(19) United States
(12) Patent Application Publication
(10) Pub. No.: US 2026/0074867 A1
(43) Pub. Date: Mar. 12, 2026

(54) METHODS AND APPARATUS FOR PRIVACY HANDLING IN PROSE LAYER-2 UE-TO-NETWORK RELAY OPERATIONS

(71) Applicant: InterDigital Patent Holdings, Inc., Wilmington, DE (US)

(72) Inventors: Michelle Perras, Montreal (CA); Samir Ferdi, Kirkland (CA); Taimoor Abbas, Sainte-Julie (CA); Martino Freda, Laval (CA); Oumer Teyeb, Montreal (CA); Jung Je Son, Warrington, PA (US)

(73) Assignee: InterDigital Patent Holdings, Inc., Wilmington, DE (US)

(21) Appl. No.: 18/998,911

(22) PCT Filed: Sep. 21, 2023
(86) PCT No.: PCT/US2023/033381

§ 371 Date: Jan. 27, 2025

Related U.S. Application Data
(60) Provisional application No. 63/410,478, filed on Sep. 27, 2022.

(51) Int. Cl. H04L 5/00; H04W 72/25

(52) U.S. Cl. CPC H04L 5/0055; H04W 72/25

(57) ABSTRACT

A relay Wireless Transmit Receive Unit (WTRU) is configured to communicate with a network and a remote WTRU and receives a link identifier update (LIU) request message including a new remote WTRU L2 ID and a new MSB of a new security identifier (ID). The relay WTRU generates a new relay WTRU L2 ID and a new LSB of the new security ID. The relay WTRU transmits to the network a request for a new remote WTRU ID and receives the new remote WTRU ID which is associated with the new L2 IDs. The relay WTRU transmits the new remote WTRU ID to the remote WTRU and a LIU response message. The relay WTRU receives an acknowledgement message. Thereafter, the new Remote WTRU ID is used for communication between the remote WTRU, the relay WTRU and the gNB.

### CROSS REFERENCE TO RELATED APPLICATIONS

This application claims the benefit of U.S. provisional patent application No. 63/410,478 filed 27 Sep. 2022 which is incorporated by reference herein in its entirety.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram illustrating the architecture model for Layer-2 WTRU-to-network relay;

FIG. 3 is a diagram illustrating the user plane protocol stack for Layer-2 WTRU-to-network relay;

FIG. 4 is a diagram illustrating the control plane protocol stack for Layer-2 WTRU-to-network relay;

FIG. 5 is signal flow diagram illustrating signal follow for Layer-2 U2N remote WTRU connection establishment;

FIG. 6 is diagram illustrating the PC5 security key hierarchy;

FIG. 7 is a signal flow diagram illustrating signal flow for a link identifier update procedure;

FIG. 8 is a signal flow diagram showing signal flow for a Relay WTRU to request a new remote UE ID from a gNB in accordance with some embodiments;

FIG. 8A is a flow diagram of an example relay WTRU procedure according to an embodiment;

FIG. 9 is a signal flow diagram showing signal flow for a remote WTRU to request a new remote UE ID from a gNB in accordance with some embodiments;

FIG. 10 is a signal flow diagram showing signal flow for a relay WTRU triggering a privacy procedure and requesting a new remote UE ID from a gNB in accordance with some embodiments; and

FIG. 11 is a signal flow diagram showing signal flow for triggering a privacy procedure and configuration of a new remote UE ID from a gNB triggered by the gNB in accordance with some embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

### Example Communication Systems

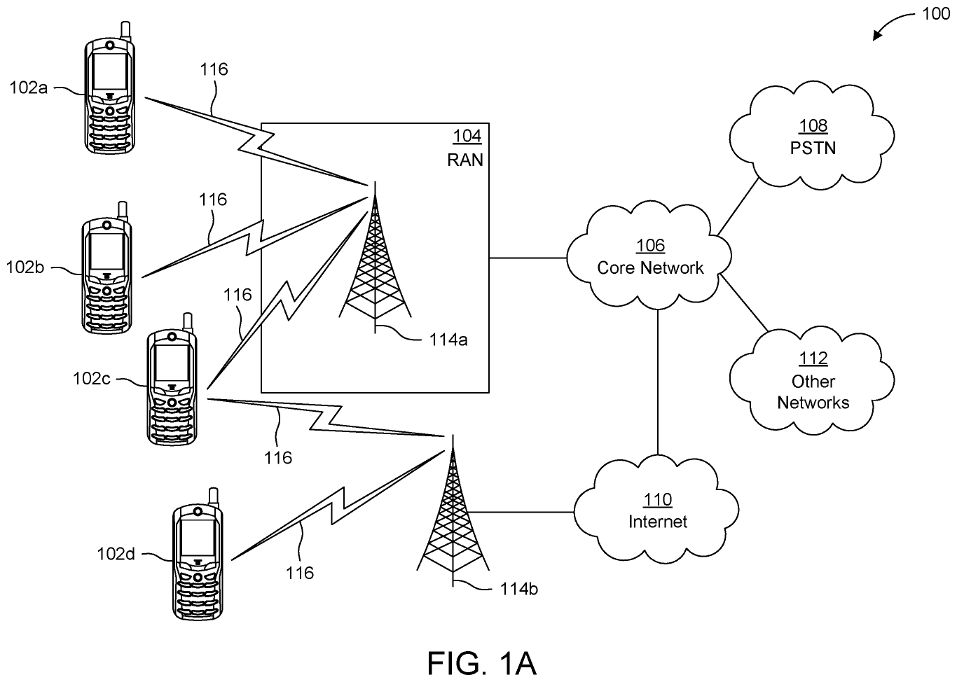

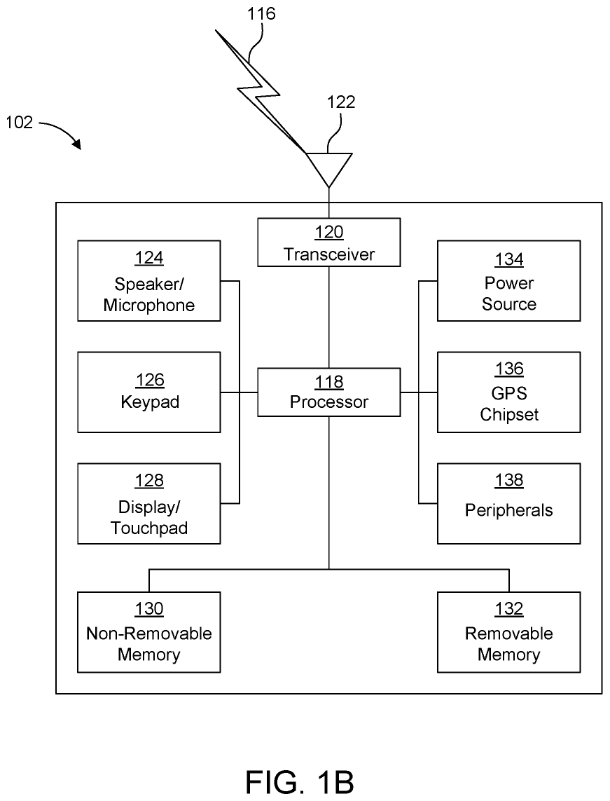

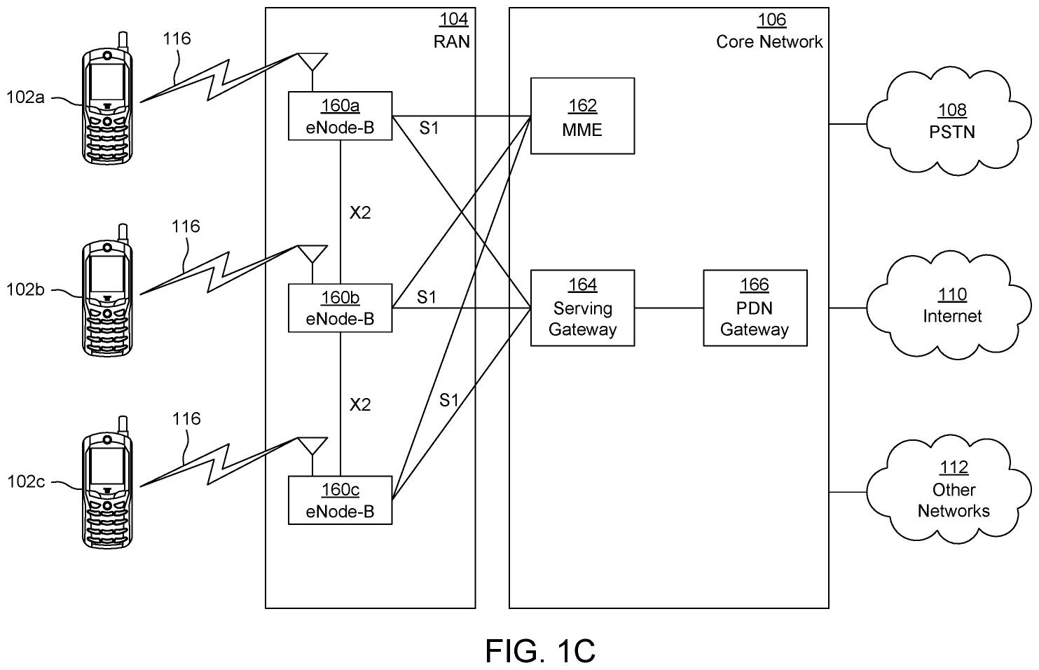

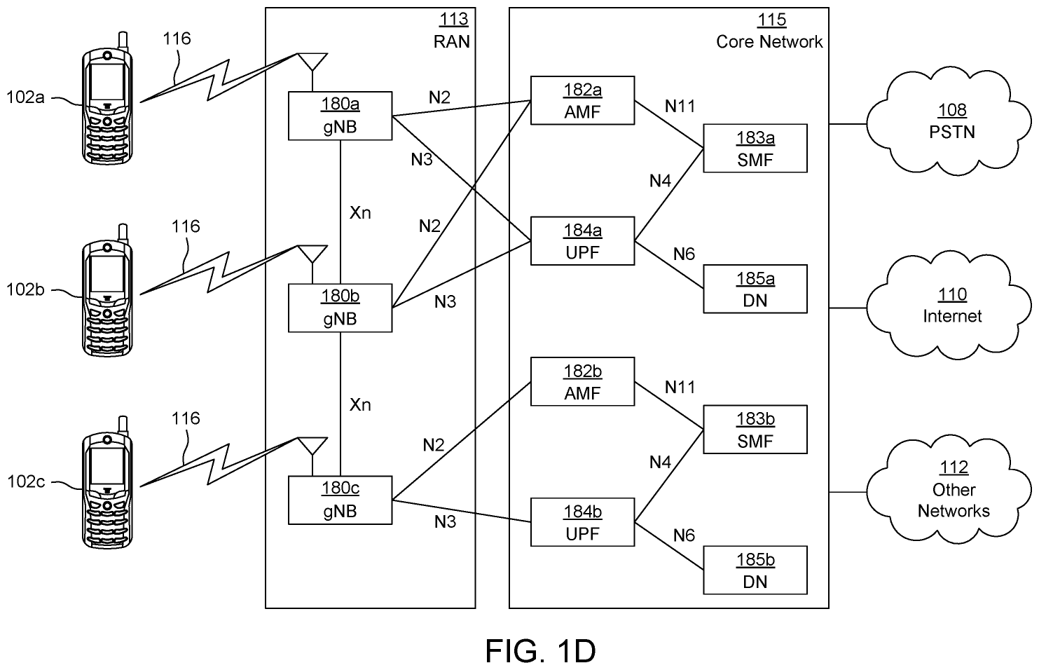

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUS 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different Packet Data Unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUS 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF a82a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Examples provided herein do not limit applicability of the subject matter to other wireless technologies, e.g., using the same or different principles as may be applicable.

As explained herein, a wireless transmit/receive unit (WTRU) may be an example of a user equipment (UE). Hence the terms UE and WTRU may be used with equal scope herein.

### Proximity Services (ProSe) and Privacy

### Layer-2 WTRU-to-Network Relay

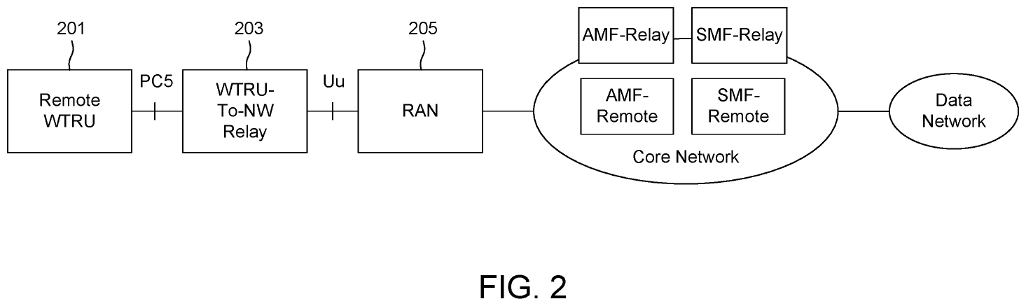

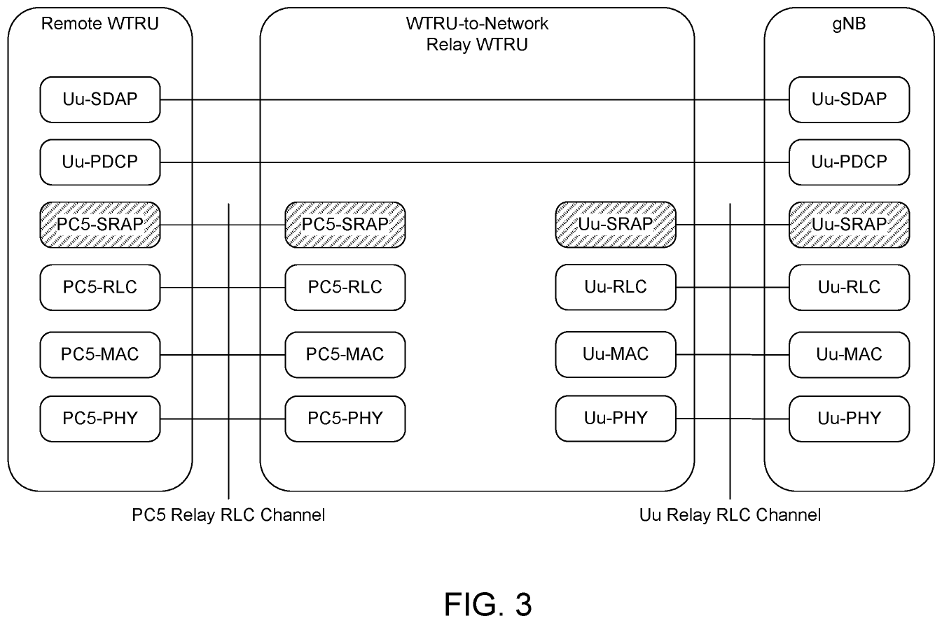

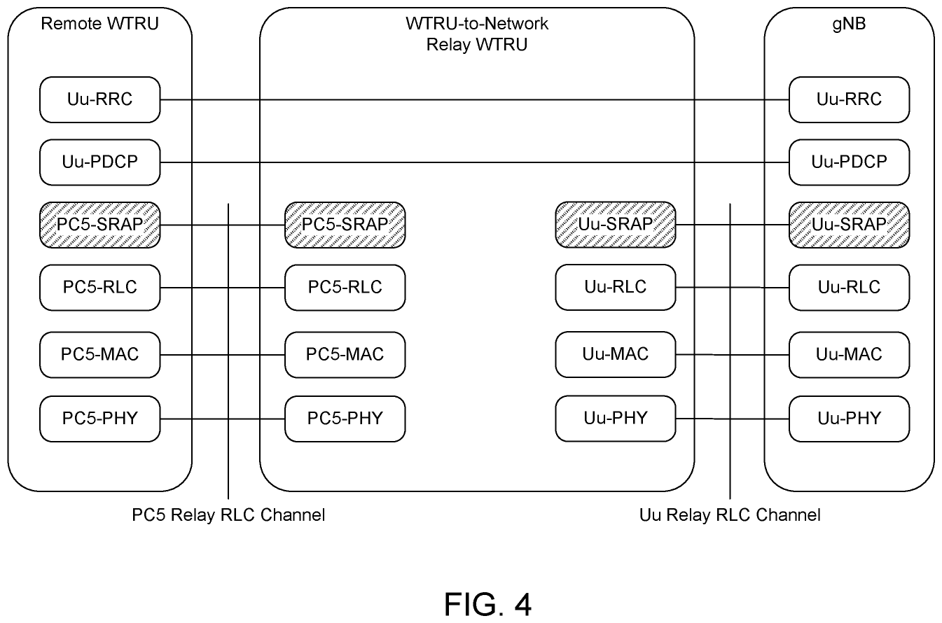

The Layer-2 WTRU-to-Network Relay provides the functionality to support connectivity to the network for Layer-2 Remote WTRUs via AS (Access Stratum) layer forwarding. FIG. 2 shows the architecture model for Layer-2 WTRU-to-network relay. As can be seen, the remote WTRU communicates with the relay WTRU over a PC5 interface, and the relay WTRU communicates with the Radio Access Network (RAN) over a Uu interface. FIG. 3 shows the data plane protocol stack for Layer-2 WTRU-to-network relay, while FIG. 4 shows the control plane protocol stack for Layer-2 WTRU-to-network relay.

After a PC5 session is established between the Layer-2 Remote WTRU 201 and the Layer-2 WTRU-to-Network Relay WTRU 203, the Layer-2 WTRU-to-Network Relay forwards RRC signaling and traffic between the Layer-2 Remote WTRU 203 and the RAN 205.

A PC5 link is uniquely identified by a PC5 link Identifier for the lifetime of the link, and the two communicating WTRUs are identified using a 24 bit Layer-2 UE ID. Packets over PC5 include the Layer-2 UE ID of the source WTRU and the destination WTRU.

An Adaptation Layer is used on the Remote WTRU 201, the U2N Relay, and the gNB for the support of L2 U2N Relay. More details on this layer are provided below.

### Sidelink Relay Adaptation Protocol

A new Adaptation Layer—called Sidelink Relay Adaptation Protocol (SRAP)—has been defined by RAN2 for the support of Layer-2 WTRU-to-Network (U2N) Relay. The new SRAP sublayer is placed below the PDCP sublayer for both control plane (CP) and user plane (UP) at both the PC5 interface and the Uu interface.

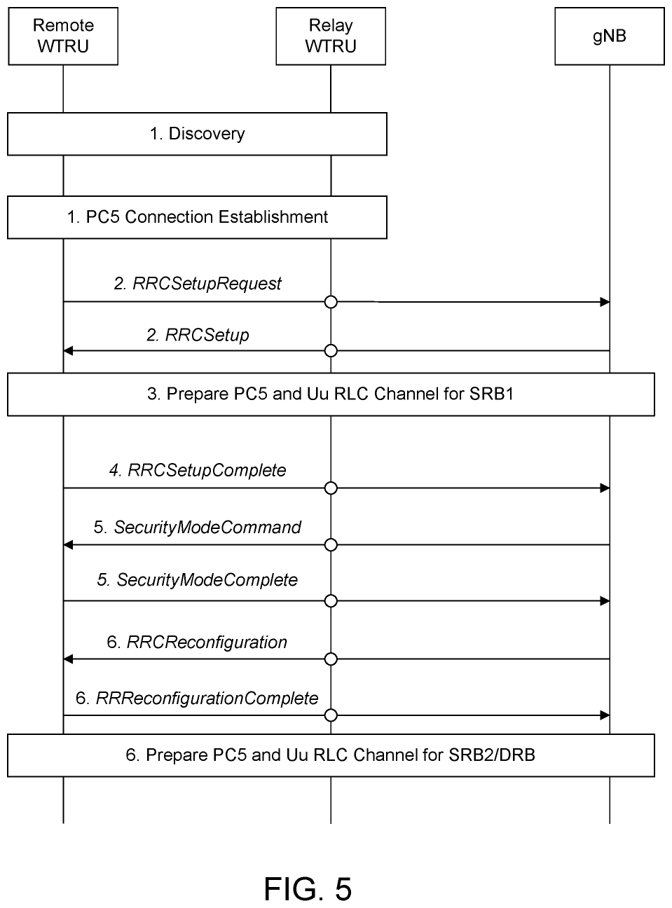

FIG. 5 is a signal flow diagram showing the signal flow for Layer-2 U2N remote WTRU connection establishment as set forth in TS 38.300 v17.1.0 NR; NR and NG-RAN Overall Description Stage 2. The U2N Relay WTRU is configured by the gNB with the Remote UE ID. The Remote WTRU obtains the Remote UE ID from the gNB via Uu RRC messages, including: RRCSetup (step 2 in FIG. 5), RRCReconfiguration (step 6 in FIG. 5), RRCResume, and RRCReestablishment

A Remote UE ID is included in both PC5 SRAP header and Uu SRAP header.

The gNB can update the Remote UE ID by sending the updated Remote UE ID via RRCReconfiguration message. The gNB can perform Remote UE ID update independently of the PC5 unicast link identifier update procedure.

The gNB configures the L2 U2N Relay WTRU with relay operation related configurations via an RRC Reconfiguration message that includes the sl-L2RelayUEConfig. The sl-L2RelayUEConfig contains the list of remote WTRUs to be relayed via the concerned relay WTRU, and for each WTRU the following is included: (i) SL-DestinationIdentity, and (ii) SRAP configuration to be used in relation to that remote WTRU

Even if the Remote WTRU is out-of-coverage and connected to the network via the WTRU-to-Network Relay, the Remote WTRU may still use the RRC protocol to talk to the gNB (as can be seen in FIG. 4).

### Privacy Handling

### PC5 Security

A security context must be established for each unicast list. The security context includes K_{NRP-sess}, NRPEK (if applicable), NRPIK, the chosen confidentiality (if applicable) and integrity algorithms, and PDCP (Packet Data Convergence Protocol) counters used with each bearer. The WTRU updates the security context associated with the unicast link when the unicast link is rekeyed. The WTRU deletes the security context associated with a unicast link once the unicast link is released.

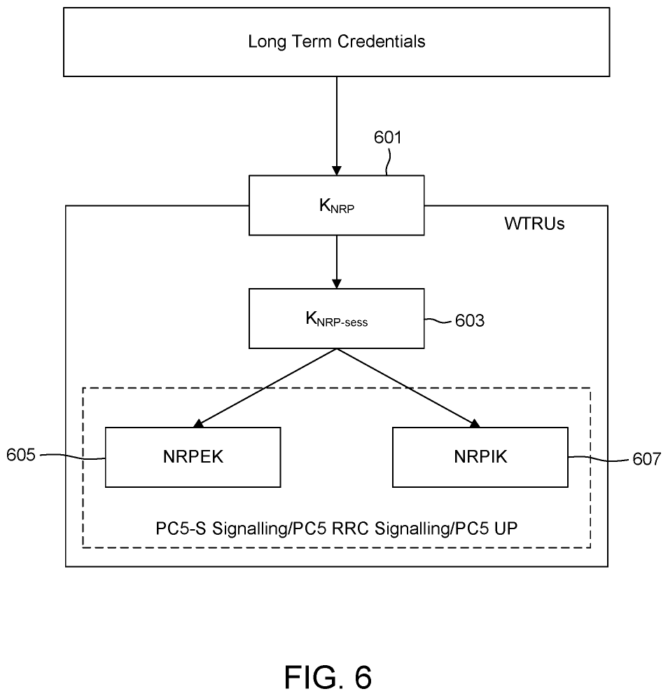

FIG. 6 shows the PC5 security key hierarchy.

The different layers of keys are as follows:
(a) Long term credentials: These are the credentials that are provisioned into the WTRU(s) and form the root of the security of the PC5 unicast link. The credentials may include symmetric key(s) or public/private key pairs depending on the particular use case. Authentication signalling is exchanged between the WTRUs to derive the K_{NRP}.
(b) K_{NRP}: a 256-bit root key that is shared between the two WTRUs communicating via PC5 unicast link. It may be refreshed by re-running the authentication signalling using the long-term credentials. Nonces are exchanged between the WTRUs and used with the K_{NRP} to generate a K_{NRP-sess} (the next layer of keys). K_{NRP} (601 in FIG. 6) may be kept even when the WTRUs have no active unicast communication session between them. The 32-bit K_{NRP} ID is used to identify K_{NRP}.
(c) K_{NRP-sess}: This is a 256-bit key that is derived by the WTRU from K_{NRP} and is used derive keys that are used to protect the transfer of data between the WTRUs. The K_{NRP-sess} (603) is derived per unicast link. During activated unicast communication session between the WTRUs, the K_{NRP-sess} may be refreshed by running the rekeying procedure. The actual keys that are used in the confidentiality and integrity algorithms are derived directly from K_{NRP-sess}. The 16-bit K_{NRP-sess} ID identifies the K_{NRP-sess}.
(d) NRPEK (605) and NRPIK (607): The NR PC5 Encryption Key (NRPEK) and NR PC5 Integrity Key (NRPIK) are used in the chosen confidentiality and integrity algorithms respectively for protecting PC5-S signalling, PC5 RRC signalling, and PC5 user plane data. They are derived from K_{NRP-sess} (603) and are refreshed automatically every time K_{NRP-sess} is changed.

### Link Identifier Update Procedure

A Link Identifier Update (LIU) procedure has been defined during V2X R16 and is reused in ProSe R17/R18 to handle privacy and avoid WTRU tracking. The LIU procedure enables the change of IDs, sent in cleartext in a message header (MAC/PDCP), at the same time.

IDs need to be changed during the same procedure run to make sure there is not linkability i.e., if a new ID is sent with an old ID, it is possible to link the new ID with the old one and continue tracking a WTRU.

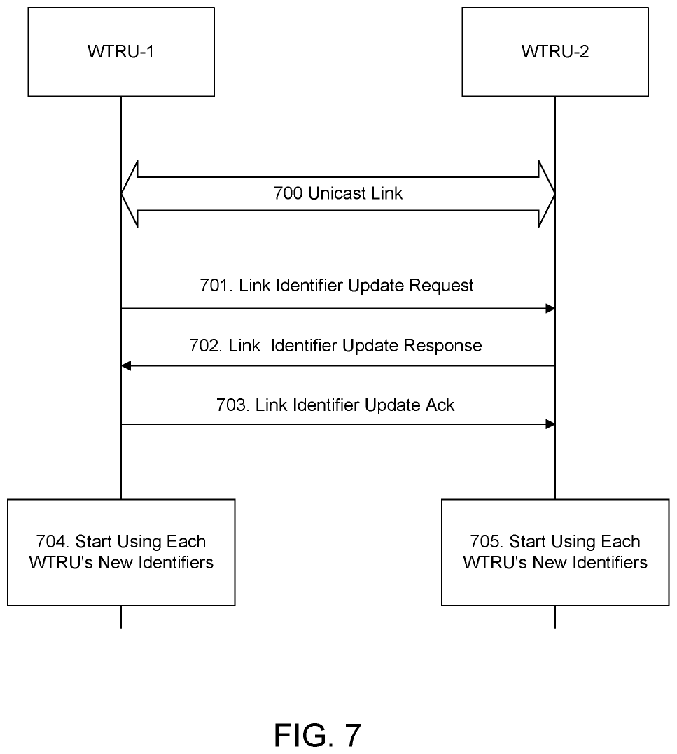

FIG. 7 is a signal flow diagram illustrating signal flow associated with a link identifier update procedure per TS 23.304 v17.1.0 Proximity based Services (ProSe) in the 5G System (5GS). With reference to FIG. 7, at 700, a unicast link is established. Message 701 is a Link Identifier Update (LIU) request which includes a changed Layer-2 ID for WTRU-1. In addition to the changed identifiers, WTRU-1 includes the new MSB (Most Significant Byte) of KNRP-sess ID in message 701. These bits are chosen so that they uniquely identify KNRP-sess at WTRU-1. The new MSB of KNRP-sess ID is selected randomly.

After reception of message 701, WTRU-2 chooses the new LSB (Least Significant Byte) of KNRP-sess ID so that they uniquely identify KNRP-sess at WTRU-2. The new LSB of KNRP-sess ID is selected randomly. WTRU-2 forms the new KNRP-sess ID from the MSB received from WTRU-1 and the LSB that WTRU-2 chose. WTRU-2 associates the new KNRP-sess ID with the updated Layer-2 IDs and uses this new KNRP-sess ID when it uses the updated Layer-2 IDs. At 702, WTRU-2 sends a LIU response message. In addition to its updated identifiers, WTRU-2 sends the LSB of KNRP-sess ID to WTRU-1 along with the received MSB of KNRP-sess ID and other identifiers received from UE-1 in the Link Identifier Update Response message.

After receiving the LIU response message 702, WTRU-1 checks that the returned MSB of KNRP-sess ID is identical to the one it sent in LIU request message 701. If that check passes, WTRU-1 forms the new KNRP-sess ID from the LSB received from WTRU-2 and the MSB chosen by WTRU-1 (in message 701). WTRU-1 associates the new KNRP-sess ID with the updated Layer-2 IDs and uses this new KNRP-sess ID when it uses the updated Layer-2 IDs. WTRU-1 sends the Link Identifier Update Ack message (message 703) to WTRU-2 including the LSB of KNRP-sess ID and other identifiers received from WTRU-2. After receiving LIU Ack message 703, WTRU-2 checks that the returned LSB of KNRP-sess ID is identical to the one sent in message 702.

At 704 and 705, after the completion of the LIU, the KNRP-sess ID is updated and used by WTRU-1 and WTRU-2 to locate the established security keys used for PC5 RRC and UP encryption and integrity.

### Trackability/Linkability Threat

As specified in the section labeled Sidelink Relay Adaptation Protocol above, the serving gNB can perform Remote UE ID update independent of the PC5 Link Identifier Update (LIU) procedure, i.e., using another procedure.

For the LIU procedure, it is required that all IDs carried in the header of PC5 messages be changed at the same time to avoid linkability and privacy issues as specified in TS 33.536 v17.1.0 Security aspects of 3GPP support for advanced Vehicle-to-Everything (V2X) services. The LIU procedure of TS 23.304 v17.1.0 Proximity based Services (ProSe) in the 5G System (5GS) permits, via a three-way message exchange, updating of all IDs during the same procedure run on both peer WTRUS.

The introduction of SRAP and Remote UE ID specified in PC5 message header introduces the possibility of a trackability/linkability threat for the WTRU by the potential eavesdropping of the Remote UE ID exchanged as cleartext. Thus, it would be beneficial to mitigate this trackability/linkability threat due to the exchange of identifiers as cleartext (e.g., in the SRAP header).

### Embodiments

ProSe layer terminology is used throughout this document. This is merely exemplary, and it should be understood that the concepts expressed herein may be applied to similar application specific layers, such as V2X layer or UAV-to-Everything (U2X) layer, which are based on ProSe.

Various embodiments are presented in the following sections, with the LIU procedure triggered on the Remote WTRU or on the U2N Relay. Also, requesting a new Remote UE ID from the gNB may be performed at the Remote UE, the U2N Relay WTRU, or both. Yet further, the change of Remote UE ID may be triggered at the gNB.

### Identifiers Update Triggered on the Remote WTRU

### Relay and Possibly Remote WTRU Request New Remote UE ID from gNB During the LIU Procedure

This embodiment supports the case where the LIU procedure is triggered by the Remote WTRU and the Relay WTRU (and possibly the Remote WTRU) requests a new Remote UE ID from the gNB during the LIU procedure run (i.e., prior to LIU procedure completion).

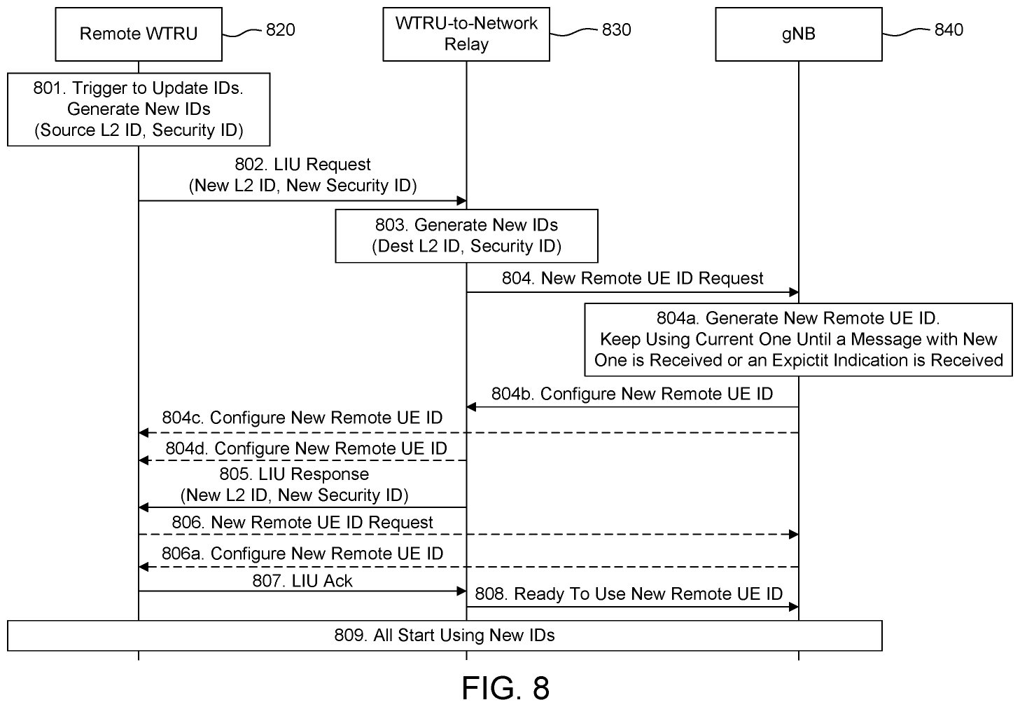

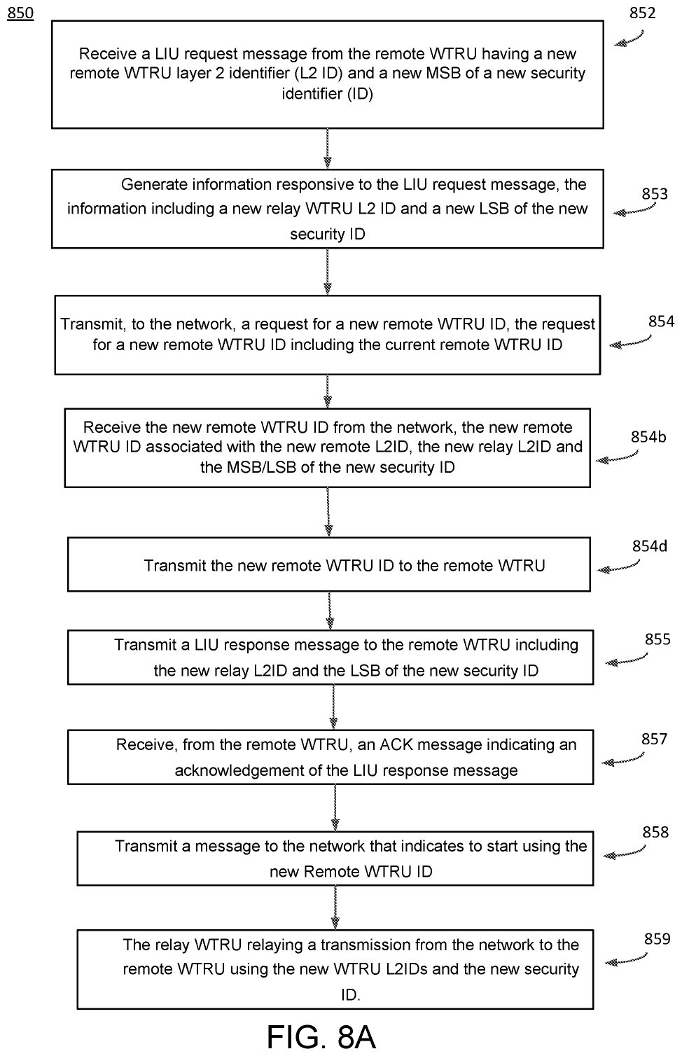

FIG. 8 is a signal flow diagram showing signal flow for a Remote WTRU and a Relay WTRU to obtain a new Remote UE ID from a gNB in accordance with some embodiments. The steps in FIG. 8 are numbered 801 through 809 and correspond to the numbers in the following description.

(Step 801) A Link Identifier Update procedure is triggered on the Remote WTRU 820 (e.g., a privacy timer expired or a trigger from the application layer is received). The Remote WTRU generates new IDs (e.g., new source L2 ID and MSB of the new KNRP-sess ID).

(Step 802) The Remote WTRU 820 sends a LIU Request message to the Relay WTRU 830 over the associated secured PC5 link. The current PC5 identifiers are used to send the message while the new IDs are included in the message payload. The Remote WTRU may include an indication for the Relay WTRU to request a new Remote UE ID from the gNB.

(Step 803) The Relay WTRU 830 receives the LIU Request message and also generates new IDs on its side (e.g., new dest L2 ID and the LSB of the new KNRP-sess ID).

(Step 804) The Relay WTRU 830 requests the gNB 840 to obtain an updated Remote UE ID associated with the Uu-SRAP and PC5-SRAP. The Relay WTRU may send this request based on the reception of an indication in the LIU Request message (message 802).

The Relay WTRU keeps both the old Remote UE ID and the new Remote UE ID (i.e., it does not immediately replace the old Remote UE ID with the new value) because it can be used during the transitory state before all UE IDs are updated. The Relay WTRU may request a new Remote UE ID for the Remote WTRU from the gNB using a SidelinkUEInformation message. The gNB may then configure a new Remote UE ID to the Relay WTRU and to the Remote WTRU using an RRC signaling (e.g., RRC Reconfiguration) message sent to each WTRU. The Relay WTRU 830 may provide the current Remote UE ID to the gNB 840 to allow the gNB to identify the Remote WTRU 820 that needs to be updated with the new Remote UE ID. The Relay WTRU may indicate in its request to the gNB if the gNB should configure the Relay WTRU and/or the Remote WTRU with the new Remote UE ID.

In more detail, the gNB generates a new Remote UE ID (804.a) and sends it to the Relay WTRU (404.b) (and may also send it separately to the Remote WTRU, 804.c). The Relay WTRU may provide the new Remote UE ID to the Remote WTRU in a PC5-RRC message (e.g., SidelinkReconfiguration message) (804d), e.g., in the case where the gNB does not configure the Remote WTRU.

The gNB may keep using the current Remote UE ID until a message is received in UL with the new Remote UE ID. Alternatively or additionally, the gNB may be configured with a timeout value for how long the current (old) Remote UE ID should be kept and monitored. This enables the gNB to forward packets that are in-transit during the update procedure and avoid dropping packets.

The gNB may use a timer for a periodic change of the Remote UE ID. The gNB may restart this timer each time the Remote UE ID is updated (or it may keep the old timer running and trigger the Remote UE ID update procedure independently of the Remote UE ID update that was triggered due to the LIU procedure).

If the Relay WTRU cannot obtain a new Remote UE ID, the Relay WTRU may send a LIU Reject message with the cause value set to, e.g., “cannot get new Remote UE ID”.

(Step 805) Upon the reception of the new Remote UE ID from the gNB (804.b), the Relay WTRU sends to the Remote WTRU the LIU Response message, including the Relay WTRU's new Layer-2 ID and the LSB of the KNRP-sess ID. The Relay WTRU may include the new Remote UE ID (that it has received from the gNB in 804.b) in the LIU Response message to allow the Remote WTRU to validate if the same Remote UE ID is also received at the Remote WTRU. Note that all of the current (already existing and established as being used) IDs, such as Remote WTRU L2 ID, Relay WTRU L2 ID, and security IDs) are used in message headers between devices (Remote WTRU, Relay WTRU, gNB) for message transfers in FIG. 8 until a new Remote WTRU ID is well established and accepted by the devices.

(Step 806) The Remote WTRU may request the new Remote UE ID (i.e. the same Remote UE ID that the Relay WTRU received in step 804) from the gNB if it has not received it in steps 804c or 805. RRC messages may be used to query the gNB, e.g. SidelinkUEInformation message, followed by the gNB providing the ID in the RRCReconfiguration message.

The gNB sends the new Remote UE ID to the Remote WTRU. The gNB keeps using the current Remote UE ID until a message is received in UL with the new Remote UE ID. Alternatively or additionally, the gNB may be configured with a timeout value representing a period that the current (old) Remote UE ID should be kept and monitored.

Alternatively, step 806 may be omitted if the gNB or Relay WTRU provides the new Remote UE ID to the Remote WTRU via RRC signaling (e.g., RRC reconfiguration) when requested by the Relay WTRU in step 4 or via LIU Response message in step 805.

The Remote WTRU may decide to query the gNB based on any of the following: (i) The Remote WTRU may be configured (e.g., during the U2N relaying setup or reconfiguration) such that, whenever it performs LIU procedure, it must follow it with a Remote UE ID update request; (ii) The Remote WTRU may autonomously decide to do this or not via implementation; (iii) Dependent on how long it has been used since the last Remote UE ID update (e.g., if it was very recent, if it was very old, etc.).

(Step 807) Once the new Remote UE ID is received, the Remote WTRU completes the LIU procedure by sending a LIU Ack message to the Relay WTRU. If the new Remote UE ID was provided in the LIU Response from the Relay WTRU, the Remote WTRU may validate that the new Remote UE ID received from the gNB is the same as the one received from the Relay WTRU. If the Remote WTRU cannot obtain a new Remote UE ID, the Remote WTRU may decide to retry a number of times or terminate the PDU session and PC5 link to the Relay WTRU.

(Step 808) Upon the reception of the LIU Ack message, the Relay WTRU may send a message to the gNB indicating that the new Remote UE ID is ready to be used. The Relay WTRU may use a SidelinkUEInformation RRC message to indicate this to the gNB. Alternatively, the Relay WTRU may indicate this implicitly by transmitting a data packet with the new Remote UE ID in the SRAP header. The indication of the readiness of the new Remote UE ID may be directly sent from the Remote WTRU (e.g., Remote WTRU sending message 8 immediately after the LIU ACK).

(Step 809) At this point, the Remote WTRU, the Relay WTRU, and the gNB start using the new IDs, including the new Remote UE ID.

FIG. 8A is a flow diagram of an example procedure 850 performed by a device such as the WTRU relay 830 performing the operations as described in the signal diagram of FIG. 8. In FIG. 8A, at 852, the relay WTRU receives a link identifier update (LIU) request message from the remote WTRU having a new remote WTRU layer 2 identifier (L2 ID) and a new MSB of a security identifier (ID). The new remote WTRU layer 2 identifier (L2 ID) and a new MSB of a security identifier (ID) may be referred to as first information.

FIG. 8A at 853, the relay WTRU generates information responsive to the LIU request message, the information including a new relay WTRU L2 ID and a new LSB of the new security ID. The new relay WTRU L2 ID and a new LSB of the new security ID may be referred to as second information.

At 854, the relay WTRU transmits, to the network, a request for a new remote WTRU ID, the request for a new remote WTRU ID including the current (the already existing/established) remote WTRU ID. In one aspect, the relay transmits a request for a new remote WTRU ID using a SidelinkUEInformation message.

At 854b, the relay WTRU receives the new remote WTRU ID from the network, the new remote WTRU ID is associated with the new remote L2 ID, the new relay L2 ID and the new MSB/LSB of the new security ID. In one aspect, the relay WTRU receives the new remote WTRU ID as a message to configure the remote WTRU with the new remote WTRU ID. At 854d, the relay WTRU transmits the new remote WTRU ID to the remote WTRU. In one aspect, the relay WTRU transmits the new remote WTRU ID in a SidelinkReconfiguration message.

At 855, the relay WTRU transmit a LIU response message to the remote WTRU including the new relay L2 ID and the new LSB of the new security ID. This may also be referred to as the second information from action 853 of FIG. 8A. Here, the relay WTRU transmits the LIU response message including the new remote WTRU ID to the remote WTRU using the current remote WTRU L2 ID, the current relay L2 ID, and the current security ID.

At 857, the relay WTRU receives, from the remote WTRU, an acknowledgement (ACK) message indicating an acknowledgement of the LIU response message at 855. Here, the relay WTRU receives the ACK message encapsulated in a header having the current remote WTRU L2 ID and the current relay L2 ID and the current security ID.

At 858, the relay WTRU transmits a message to the network that indicates to start using the new remote WTRU ID.

At 859, the relay WTRU has a new remote WTRU. The relay WTRU can henceforth use the new WTRU L2 IDs and the new security ID to relay a transmission from the network to the remote WTRU.

### Remote WTRU Requests a New Remote UE ID from gNB

This embodiment enables the Remote WTRU to request a new Remote UE ID from the gNB and to share this new Remote UE ID with the Relay WTRU during the LIU procedure run (i.e., prior to LIU procedure completion).

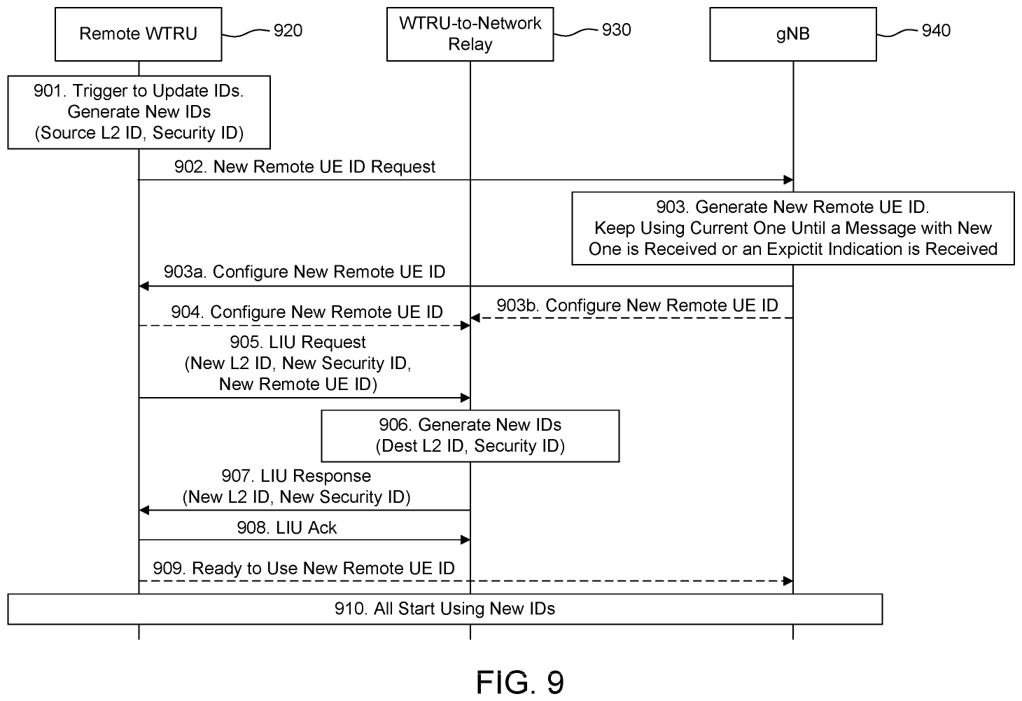

FIG. 9 is a signal flow diagram illustrating an exemplary signal flow for such an embodiment. The steps in FIG. 9 are numbered 901 through 910 and correspond to the numbers in the following description.

(Step 901) A privacy procedure is triggered at the Remote WTRU 920 (e.g., a privacy timer expired or a trigger from the application layer is received). The Remote WTRU generates new IDs (e.g., new source L2 ID and new security ID).

(Step 902) The Remote WTRU 920 sends a request to the gNB 940 to obtain an updated Remote UE ID. RRC messages may be used to query the gNB, e.g., SidelinkUEInformation message, followed by the gNB 940 providing the ID in the RRCReconfiguration message. The Remote WTRU may indicate in its request to the gNB if the gNB should also send the new Remote UE ID to the Relay WTRU.

(Step 903) The gNB generates a new Remote UE ID and sends it to the Remote WTRU (step 3a) and may also send it separately to the Relay WTRU (step 3b). The gNB keeps using the current Remote UE ID until a message is received in UL with the new Remote UE ID. Alternatively, the gNB may be configured with a timeout value for how long the current (old) Remote UE ID should be kept and monitored (as defined in section labeled Relay and possibly Remote WTRU request new Remote UE ID from gNB during the LIU procedure at steps 804a and 804b). If the Remote WTRU 920 cannot obtain a new Remote UE ID, the Remote WTRU may decide to retry a number of times or terminate the PDU session and PC5 link to the Relay.

(Step 904) The Remote WTRU 920 may configure the new Remote UE ID at the Relay WTRU 930 using RRC signaling.

(Step 905) The Remote WTRU sends a LIU Request message to the Relay WTRU over the associated PC5 link. The current PC5 identifiers are used to send the message while the new IDs are specified in the message payload. The new Remote UE ID may be included in the LIU Request payload with the other new identifiers.

(Step 906) The Relay WTRU 930 receives the LIU Request message and also generates new IDs on its side (e.g., new dest Layer-2 ID and new security ID).

(Step 907) Once the Relay WTRU 930 has received the new Remote UE ID, it sends the LIU Response message to the Remote WTRU 920, including the Relay's new Layer-2 ID and security ID.

(Step 908) The Remote WTRU 920 completes the LIU procedure by sending a LIU Ack message to the Relay WTRU 930.

(Step 909) The Remote WTRU (or the Relay) may send a message to the gNB 940 indicating that the new Remote UE ID may start to be used. A SidelinkUEInformation RRC message may be used to indicate this to the gNB. Alternatively, the relay WTRU may confirm the use of the new remote UE ID by including the new remote UE ID in the adaptation layer header with data being relayed from the remote WTRU.

(Step 910) At this point, the Remote WTRU, the Relay WTRU, and the gNB start using the new IDs, including the new Remote UE ID.

In an alternative embodiment to the above, the procedure could be modified as below with the LIU Request being sent prior to requesting a new Remote UE ID. Particularly, the Remote WTRU may send a LIU request message to the relay WTRU prior to sending a separate message to the gNB to request a new Remote UE ID associated with Uu-SRAP and PC5-SRAP from the gNB, which is an RRC message and may include associated relay WTRU info (e.g., a unique Relay identifier). Upon reception of the request from the Remote WTRU, the gNB may generate a new Remote UE ID, while continuing to use the current one until explicit indication is received. The gNB may send the new Remote UE ID to the Remote WTRU and to the Relay WTRU using RRC signaling (e.g., RRC Reconfiguration message). Upon reception of the new Remote UE ID, the Relay WTRU may send the LIU Response message to the Remote WTRU, including the Relay WTRU's new Layer-2 ID and new security ID, and may include the new Remote UE ID. The Remote WTRU may send a LIU Ack message upon reception of the new Remote UE ID and LIU Response message. Steps 9 to 10 may remain the same as in FIG. 9.

### Identifiers Update Triggered by the Relay

The following embodiment and its alternatives described below support the case where the LIU procedure is triggered by the Relay WTRU and the Relay WTRU requests the new Remote UE ID from the gNB during the LIU procedure run (i.e., prior to LIU procedure completion).

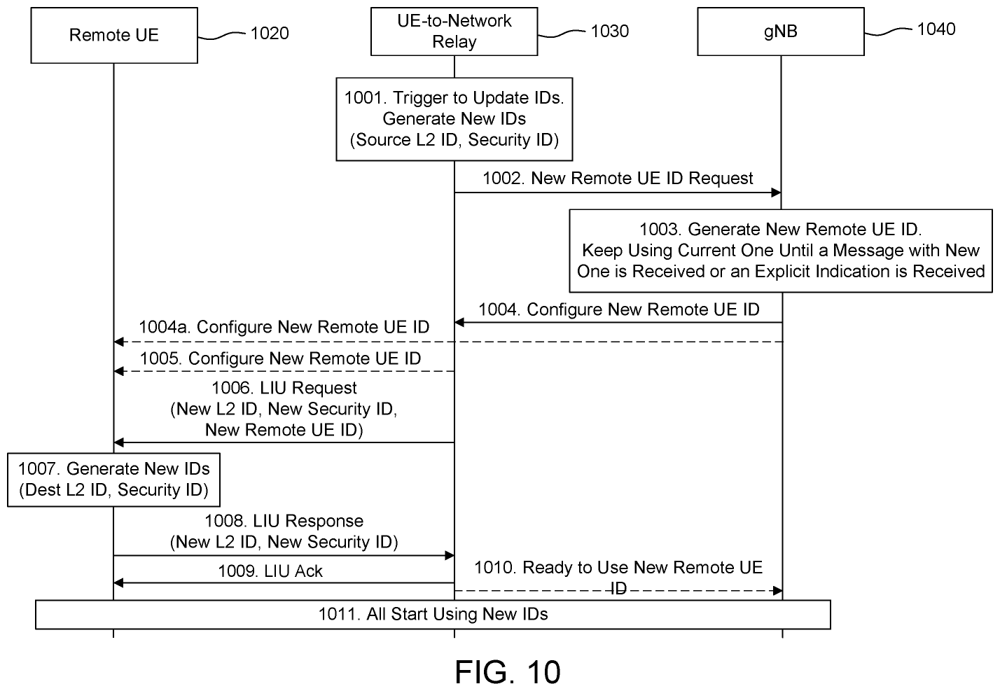

FIG. 10 is a signal flow diagram illustrating an exemplary signal flow for such an embodiment. The steps in FIG. 10 are numbered 1001 through 1011 and correspond to the numbers in the following description.

(Step 1001) A privacy procedure is triggered at the Relay WTRU 1030 (e.g., a privacy timer expired). The Relay generates new PC5 IDs (e.g., new source L2 ID and new security ID).

(Step 1012) The Relay WTRU 1030 requests an updated Remote UE ID associated with the Uu-SRAP and PC5-SRAP from the gNB 1040 using RRC signaling. The Relay WTRU may specify the current Remote UE ID when requesting a new one from the gNB, enabling the gNB to identify which Remote WTRU needs to be updated with the new Remote UE ID.

(Step 1003) The gNB 1040 generates a new remote UE ID (as defined in FIG. 8 step 804, 804a, 804b).

(Step 1004) The gNB sends the new Remote UE ID to the Relay WTRU 1030, and may include an indication requesting the Relay WTRU to update the Remote WTRU 1020. The gNB may also send the new Remote UE ID to the Remote WTRU (1004a).

(Step 1005) The Relay WTRU may send the new Remote UE ID to the Remote WTRU using RRC signaling if it has received an indication requesting it.

(Step 1006) The Relay WTRU sends a LIU Request message to the Remote WTRU. The current PC5 identifiers are used to send the message, while the new PC5 IDs are specified in the message payload. The new Remote UE ID may be included in the LIU Request message payload if not already sent to the Remote WTRU over RRC signaling, or in addition to RRC signaling. If the Relay WTRU cannot obtain a new Remote UE ID, the Relay WTRU does not trigger the LIU procedure with the Remote WTRU and may decide to terminate the PC5 link with the cause value set to, e.g., “cannot get new Remote UE ID”. Alternatively, the Relay may send a new PC5 message, e.g., Link Indication, to inform the Remote WTRU about the failure to obtain a new Remote UE ID and let the Remote WTRU decide if the PC5 link should be terminated or not. Yet another alternative is to use the Keepalive message to inform the Remote WTRU about the failure to obtain a new Remote UE ID.

(Step 1007) The Remote WTRU receives the LIU Request message and also generates new PC5 IDs on its side (e.g., new destination L2 ID and new security ID). The Remote WTRU keeps track of the new Remote UE ID.

(Step 1008) The Remote WTRU sends the LIU Response message to the Relay, including its new Layer-2 ID and new security ID as well as the new IDs as received on the LIU Request message.

(Step 1009) The Relay WTRU completes the LIU procedure by sending a LIU Ack message to the Remote WTRU.

(Step 1010) The Relay WTRU may send a message to the gNB indicating that the new Remote UE ID may start to be used.

(Step 1011) At this point, the Remote WTRU, the Relay WTRU, and the gNB start using the new IDs, including the new Remote UE ID.

### Remote/Relay WTRU Selects the Procedure Based on the RRC State of the Remote/Relay WTRU

In an embodiment, the procedure used to update the remote UE ID at the remote WTRU and the relay WTRU may depend on the RRC state of the relay/remote WTRU. Specifically, this embodiment may be used to avoid the need to initiate an RRC connection establishment at the remote WTRU.

For example, if the remote WTRU is in RRC_CONNECTED state, it may use the procedure above whereby the remote WTRU receives the remote WTRU ID directly from the gNB in an RRCReconfiguration message. On the other hand, if the remote WTRU is in RRC_IDLE/RRC_INACTIVE state, it may use the procedure above where the remote WTRU receives the remote UE ID directly from the relay WTRU using PC5 RRC signaling (i.e., without Uu RRC signaling). This ensures that the remote WTRU remains in RRC_IDLE/RRC_INACTIVE state during the update procedure. In this case, the gNB may send, together with the new Remote UE ID, an indication that the new Remote UE ID is not sent to the Remote WTRU by the gNB.

In another alternative, how the remote WTRU initiates the procedure for obtaining a new Remote UE ID may depend on the RRC state at the remote WTRU. For example, if the remote WTRU is in RRC_IDLE/RRC_INACTIVE state, it may initiate a connection establishment prior to initiating the Remote UE ID update procedure. Alternatively, if the remote WTRU is in RRC_CONNECTED, it may use a different procedure to request a Remote UE ID update.

### Remote UE ID Update Triggered on the gNB

The following embodiment and its alternatives described below support the case where the gNB autonomously decides to update the Remote UE ID.

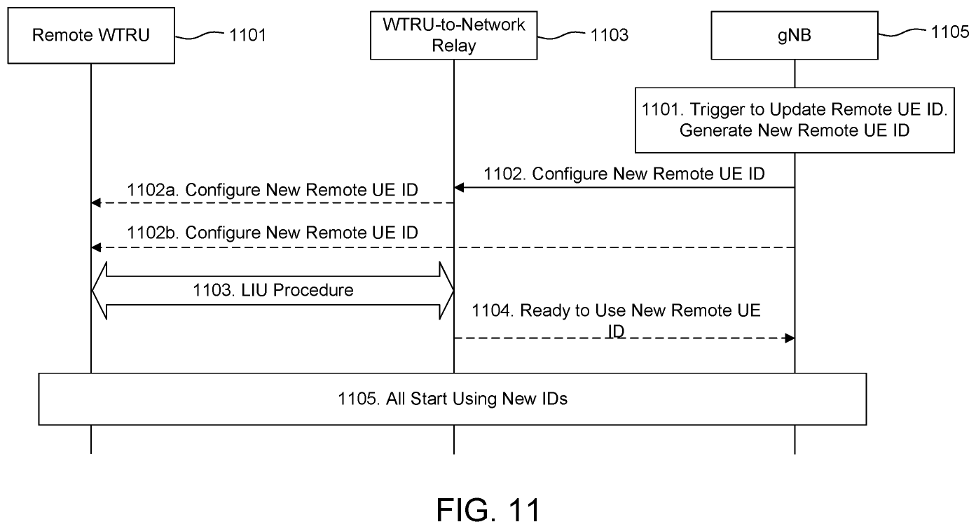

FIG. 11 is a signal flow diagram illustrating an exemplary signal flow for such an embodiment. The steps in FIG. 11 are numbered 1101 through 1105 and correspond to the numbers in the following description.

(Step 1101) A Remote UE ID update procedure is triggered by the gNB 1140 (e.g., responsive to expiration of a timer). The gNB generates a new Remote UE ID.

(Step 1102) The gNB sends the updated Remote UE ID associated with the Uu-SRAP and PC5-SRAP to the Relay WTRU 1130 and indicates if the Relay WTRU should configure the Remote WTRU 1120 or not. The Relay WTRU 1130 keeps track of the new Remote UE ID. If the gNB has indicated that the Relay WTRU should configure the Remote WTRU, the Relay sends the new Remote UE ID to the Remote WTRU using RRC signaling. Alternatively, the new Remote UE ID may be sent during the LIU procedure at step 3. If the gNB has indicated that the Relay does not have to update the Remote WTRU, the gNB sends the new Remote UE ID to the Remote WTRU using RRC signaling.

(Step 1103) The Relay WTRU 1130 triggers the LIU privacy procedure with the Remote WTRU. The Relay WTRU sends a LIU Request message to the Remote WTRU 1120 including its new PC5 IDs. The new Remote UE ID may be included as a new ID in the LIU message. The Remote WTRU sends the LIU Response message to the Relay WTRU. The Remote WTRU waits for the new Remote UE ID to be received before sending the LIU Response message. The Relay WTRU completes the LIU procedure by sending a LIU Ack message to the Remote WTRU.

(Step 1104) The Relay (or Remote) WTRU may send a message to the gNB indicating that the new Remote UE ID may start to be used.

(Step 1105) At this point, the Remote WTRU, the Relay, and the gNB start using the new IDs, including the new Remote UE ID.

In a first alternative embodiment to the above, the Remote WTRU 1120 may trigger the LIU procedure with the Relay WTRU 1130 at step 1103 (instead of the Relay triggering the LIU procedure). The Remote WTRU and Relay WTRU may negotiate which WTRU should trigger the LIU procedure during the PC5 unicast link establishment.

In a second alternative embodiment to the above, the gNB 1140 may send the new Remote UE ID to the Remote WTRU 1120 prior to sending it to the Relay WTRU 1130, i.e., steps 1102 and 1103 are swapped. In this case, the Remote WTRU 1120 triggers the LIU procedure with the Relay WTRU 1130. The Remote WTRU or the Relay may inform the gNB to start using the new Remote UE ID once the LIU Ack message is sent/received.

The gNB may send the new Remote UE ID to the Remote WTRU, and the Remote WTRU triggers the LIU procedure with the Relay WTRU and sends the new Remote UE ID to the Relay WTRU using the LIU Request or LIU Ack message or RRC signaling. The Remote WTRU may inform the gNB to start using the new Remote UE ID once the LIU Ack message is sent.

In a fourth alternative embodiment, the gNB may update the Remote UE ID and send it to the Remote WTRU and to the Relay WTRU. The Remote WTRU and Relay WTRU may start using the new Remote UE ID immediately, without triggering the LIU procedure. The LIU procedure may be run (triggered at the Remote WTRU or the Relay WTRU) as usual, which mandates the change of Remote UE ID at the same time, even if the gNB was previously updated independently of the LIU procedure.

### Link Identifier Update Triggered by the Remote WTRU or Relay WTRU Using Pre-Configured Remote UE IDs

In this embodiment, the Relay WTRU or Remote WTRU may obtain a set of Remote UE IDs from the gNB during a RRC configuration procedure, and then use new Remote UE IDs from the set during subsequent LIU procedure runs.

In such an embodiment, the behavior at the Remote WTRU may be as described in the following seven steps.

(Step 1) The Remote WTRU requests a Remote UE ID configuration from the gNB with an indication requesting multiple Remote UE IDs (e.g., if privacy is required in the PC5 link). [Option 2] The message may include a privacy timer for when a new Remote UE ID should be used.

(Step 2) The Remote WTRU receives a configuration message including a set of Remote UE IDs (e.g., in priority order). The WTRU stores the set of Remote UE IDs and uses the first Remote UE ID during communication over PC5.

(Step 3) Based on a privacy trigger (timer, application), the Remote WTRU sends to the Relay WTRU a LIU Request message including a new Remote UE ID from the Remote UE ID set (e.g., next in priority order), along other Identifiers for the Remote WTRU.

(Step 4) The Remote WTRU receives from the Relay WTRU a LIU Response message accepting the change of Remote UE ID (including new Relay IDs).

(Step 5) [Option1b] The Remote WTRU sends to the gNB a request or indication message to initiate usage of the new Remote UE ID (e.g., as selected at step 3). The selected new Remote UE ID is specified in the message.

(Step 6) [Option 1b] The Remote WTRU may receive from the gNB a response message informing the Remote WTRU of the start of using the new Remote UE ID.

(Step 7) The Remote WTRU sends a LIU Ack message to confirm that the change of all IDs is complete.

In an embodiment that utilizes pre-configured remote WTRU IDs, the behavior at the Relay WTRU may be as described in the following eight steps.

(Step 1) The Relay WTRU obtains from the gNB a configuration for the Remote WTRU including a set of Remote UE IDs (as above).

(Step 2) The Relay WTRU uses the first Remote UE ID during communication over PC5 and Uu.

(Step 3) The Relay WTRU receives from the Remote WTRU a LIU Request including a new Remote UE ID from the Remote UE ID set (along other IDs).

(Step 4) The Relay WTRU validates that the received Remote UE ID is specified in the set of Remote UE IDs obtained in step 1. If not, the Relay WTRU may terminate the PC5 link or use the value as received on the LIU request message.

(Step 5) [Option1a] The Relay may send to the gNB a request or indication message to initiate usage of the new Remote UE ID (e.g., as received at step 3). The selected new Remote UE ID is specified in the message.

(Step 6) [Option 1a] The Relay WTRU may receive from the gNB a response message informing of the start of using the new Remote UE ID.

(Step 7) The Relay WTRU may send to the Remote WTRU a LIU Response accepting the change of Remote UE ID (including new Relay IDs).

(Step 8) The Relay WTRU receives from the Remote WTRU a LIU Ack message confirming that the change of all IDs is complete.

In an embodiment that utilizes pre-configured remote WTRU IDs, the behavior at the gNB may be as described in the following three steps.

(Step 1) The gNB receives a request from the Remote WTRU (or Relay WTRU) for a configuration with indication requesting multiple Remote UE IDs (e.g., if privacy required in the PC5 link). Alternately, the request may include a timer for when to change Remote UE ID. The gNB may allocate multiple Remote UE IDs and send them (e.g., in priority order) to the Remote WTRU (or Relay WTRU) in a configuration response message.

(Step 2) [Option 1a/1b] The gNB receives from the Relay WTRU (or Remote WTRU) a request or indication message to initiate usage of the new Remote UE ID. The gNB starts monitoring traffic using the new Remote UE ID and stops using current Remote UE ID (the gNB may use a timer to limit usage of current/old Remote UE ID as described above).

(Step 3) [Option1a/1b] The gNB may send to the Relay WTRU (or Remote WTRU) a response message informing it of the start of using the new Remote UE ID.

Alternatively to Option 1a/1b above, which uses messaging with the gNB, the following alternatives are proposed. These options may allow implicit change of Remote UE ID with the gNB by detection of usage of a new Remote UE ID used in UL traffic.

Option 2: the gNB may start the timer and start monitoring usage of the new Remote UE ID (e.g., next in the set) when the timer expires. In this case, neither the Remote WTRU nor the Relay WTRU needs to inform the gNB about the usage of a new Remote UE ID via messaging (i.e., as in option1a/1b).

Option 3: the gNB keeps using the current Remote UE ID until a message is received in UL with the new Remote UE ID. With this option, the gNB does not need to start a timer as in option 2, and monitors the Remote UE ID (current and new) used in UL.

Option 4: The list of new Remote UE IDs is only configured on the Remote WTRU (or only on the Relay WTRU). In this case, the Remote WTRU (or Relay WTRU) sends the new Remote UE ID to the Relay WTRU (or Remote WTRU) when the LIU procedure is triggered using RRC signaling or a LIU message.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1-20. (canceled)

21. A relay Wireless Transmit Receive Unit (WTRU) configured to communicate with a network and a remote WTRU via respective air interfaces, the WTRU further configured to:
receive a link identifier update (LIU) request message from the remote WTRU having first information, the first information comprising a new remote WTRU layer 2 identifier (L2 ID) and a new most significant byte (MSB) of a new security identifier (ID);
generate second information responsive to the LIU request message, the second information comprising a new relay WTRU L2 ID and a new least significant byte (LSB) of the new security ID;
transmit, to the network, a request for a new remote WTRU ID, the request for a new remote WTRU ID comprising a current remote WTRU ID;
receive the new remote WTRU ID from the network, the new remote WTRU ID associated with the first information and the second information;
transmit the new remote WTRU ID to the remote WTRU;
transmit a LIU response message to the remote WTRU, the LIU response message comprising the second information;
receive, from the remote WTRU, an acknowledgement (ACK) message indicating an acknowledgement of the LIU response message; and
transmit a message to the network responsive to the ACK message, wherein the message indicates to start using the new Remote WTRU ID.

22. The relay WTRU of claim 21, wherein the relay WTRU transmits, to the network, a request for a new remote WTRU ID, wherein the request for a new remote WTRU ID comprises a SidelinkUEInformation message.

23. The relay WTRU of claim 21, wherein the relay WTRU receives the new remote WTRU ID from the network in a message to configure the remote WTRU with the new remote WTRU ID.

24. The relay WTRU of claim 21, wherein the relay WTRU transmits the new remote WTRU ID to the remote WTRU using a SidelinkReconfiguration message.

25. The relay WTRU of claim 21, wherein the relay WTRU transmits the LIU response message to the remote WTRU, wherein a LIU response message header comprises the current remote WTRU ID, a current relay WTRU ID, and a current security ID.

26. The relay WTRU of claim 21, wherein the relay WTRU receives the ACK message having first and second current IDs, and the current remote WTRU ID encapsulated in a header.

27. The relay WTRU of claim 21, further comprising the relay WTRU relaying a transmission from the network to the remote WTRU, the transmission comprising a message using the new remote WTRU ID, the new relay WTRU L2 ID, the new remote WTRU L2 ID, and the new security ID.

28. A method performed by a relay Wireless Transmit Receive Unit (WTRU) configured to communicate with a network and a remote WTRU via respective air interfaces, the method comprising:
receiving a link identifier update (LIU) request message from the remote WTRU having first information, the first information comprising a new remote WTRU layer 2 identifier (L2 ID) and a new most significant byte (MSB) of a new security identifier (ID);
generating second information responsive to the LIU request message, the second information comprising a new relay WTRU L2 ID and a new least significant byte (LSB) of the new security ID;
transmitting, to the network, a request for a new remote WTRU ID, the request for a new remote WTRU ID comprising a current remote WTRU ID;
receiving the new remote WTRU ID from the network, the new remote WTRU ID associated with the first information and the second information;
transmitting the new remote WTRU ID to the remote WTRU;
transmitting a LIU response message to the remote WTRU, the LIU response message comprising the second information;
receiving, from the remote WTRU, an acknowledgement (ACK) message indicating an acknowledgement of the LIU response message; and
transmitting a message to the network responsive to the ACK message, wherein the message indicates to start using the new Remote WTRU ID.

29. The method of claim 28, wherein transmitting, to the network, a request for a new remote WTRU ID comprises transmitting a SidelinkUEInformation message to the network.

30. The method of claim 28, wherein receiving the new remote WTRU ID from the network comprises receiving the new remote WTRU ID from the network in a message to configure the remote WTRU with the new remote WTRU ID.

31. The method of claim 28, wherein transmitting the new remote WTRU ID to the remote WTRU comprises transmitting a SidelinkReconfiguration message to the remote WTRU.

32. The method of claim 28, wherein transmitting a LIU response message to the remote WTRU comprises transmitting the LIU response message having a LIU response message header comprising the current remote WTRU ID, a current relay WTRU ID, and a current security ID.

33. The method of claim 28, wherein receiving, from the remote WTRU, an acknowledgement (ACK) message indicating an acknowledgement of the LIU response message comprises receiving the ACK message encapsulated in a header having current Identifiers for the remote WTRU and the relay WTRU and a current security identifier.

34. The method of claim 28, further comprising:
relaying a transmission from the network to the remote WTRU via the relay WTRU, wherein the transmission comprises a message using the new remote WTRU ID, the new relay WTRU L2 ID, and the new security ID.

35. A non-transient computer-readable storage medium comprising instructions which, when executed by a processor, perform a method comprising:
receiving a link identifier update (LIU) request message from a remote WTRU having first information, the first information comprising a new remote WTRU layer 2 identifier (L2 ID) and a new most significant byte (MSB) of a new security identifier (ID);
generating second information responsive to the LIU request message, the second information comprising a new relay WTRU L2 ID and a new least significant byte (LSB) of the new security ID;
transmitting, to a network, a request for a new remote WTRU ID, the request for a new remote WTRU ID comprising a current remote WTRU ID;
receiving the new remote WTRU ID from the network, the new remote WTRU ID associated with the first information and the second information;
transmitting the new remote WTRU ID to the remote WTRU;
transmitting a LIU response message to the remote WTRU, the LIU response message comprising the second information;
receiving, from the remote WTRU, an acknowledgement (ACK) message indicating an acknowledgement of the LIU response message; and
transmitting a message to the network responsive to the ACK message, wherein the message indicates to start using the new Remote WTRU ID.

36. The non-transient computer-readable storage medium of claim 35, wherein transmitting, to the network, a request for a new remote WTRU ID comprises transmitting a SidelinkUEInformation message to the network.

37. The non-transient computer-readable storage medium of claim 35, wherein receiving the new remote WTRU ID from the network comprises receiving the new remote WTRU ID from the network in a message to configure the remote WTRU with the new remote WTRU ID.

38. The non-transient computer-readable storage medium of claim 35, wherein transmitting the new remote WTRU ID to the remote WTRU comprises transmitting a SidelinkReconfiguration message to the remote WTRU.

39. The non-transient computer-readable storage medium of claim 35, wherein transmitting a LIU response message to the remote WTRU comprises transmitting the LIU response message having a LIU response message header comprising the current remote WTRU ID, a current relay WTRU ID, and a current security ID.

40. The non-transient computer-readable storage medium of claim 35, wherein receiving, from the remote WTRU, an acknowledgement (ACK) message indicating an acknowledgement of the LIU response message comprises receiving the ACK message encapsulated in a header having current Identifiers for the remote WTRU and the relay WTRU and a current security identifier.
